(19) United States
(12) Patent Application Publication
(10) Pub. No.: US 2024/0025377 A1
(43) Pub. Date: Jan. 25, 2024

(54) ACTUATOR FOR SUPPLYING COMPRESSED AIR FOR CLEANING AND DRYING SENSOR OF VEHICLE

(71) Applicants: Hyundai Motor Company, Seoul (KR); Kia Corporation, Seoul (KR); DAEDONG MOVEL SYSTEM Co., Ltd., Siheung-si (KR)

(72) Inventors: Je Yeon Kim, Hwaseong-Si (KR); Jong Geon Lee, Hwaseong-Si (KR); Yoon Geun Cho, Daegu (KR); Byoung Jo Kim, Gwangmyeong-Si (KR); Wan Cheol Lee, Incheon (KR); Yun Soo Kim, Incheon (KR)

(73) Assignees: Hyundai Motor Company, Seoul (KR); Kia Corporation, Seoul (KR); DAEDONG MOVEL SYSTEM Co., Ltd., Siheung-si (KR)

(21) Appl. No.: 18/203,545

(22) Filed: May 30, 2023

(30) Foreign Application Priority Data
Jul. 25, 2022 (KR) 10-2022-0091520

(51) Int. Cl. B60S 1/56; B60S 1/54

(52) U.S. Cl. CPC B60S 1/56; B60S 1/54

(57) ABSTRACT

An actuator for supplying compressed air for cleaning and drying a sensor of a vehicle, includes a compression unit configured to compress air from outside to form high-pressure compressed air, a drying unit configured to receive the compressed air compressed to a high pressure by the compression unit via a movement passage to remove moisture from the compressed air, and a storage tank connected to the drying unit via a connecting passage and configured to store the compressed air passing through the drying unit to be supplied to the vehicle, wherein the compressed air is stored in the storage tank so that high-pressure compressed air is generated and sprayed to the sensor of the vehicle, cleaning and drying the same in a short time.

### CROSS-REFERENCE TO RELATED APPLICATION

The present application claims priority to Korean Patent Application No. 10-2022-0091520, filed on Jul. 25,2022, the entire contents of which is incorporated herein for all purposes by this reference.

### BACKGROUND OF THE PRESENT DISCLOSURE

### Field of the Present Disclosure

The present disclosure relates to an actuator for supplying compressed air for cleaning and drying a sensor of a vehicle. More particularly, it relates to a compressed air supply actuator for a vehicle configured to spray high-pressure compressed air to dry a sensor of a vehicle after periodic cleaning of the sensor, removing cleaning liquid from the sensor.

### Description of Related art

Recently, vehicles are provided with various convenience devices in addition to features that reduce accidents occurring during traveling, and are evolving into electronic systems. To reduce the burden of driving, the number of vehicles provided with a semi-autonomous driving mode or an autonomous driving mode is rapidly increasing.

Semi-autonomous driving or autonomous driving with reduced driver intervention is a technology in which a vehicle drives by itself according to human driving logic by recognizing the contour of a road, surrounding vehicles, pedestrians, traffic lights, etc. using a camera sensor, a laser sensor, a Light Detection and Ranging (LiDAR) sensor, etc.

However, when a sensor mounted on a vehicle, regardless of whether the sensor is inside the vehicle or exposed to the outside thereof, is stained with foreign substances or wetted with rainwater while traveling on the road, the detecting ability thereof may deteriorate. For the present reason, to secure operation reliability of the electronic components for semi-autonomous driving or autonomous driving of the vehicle, detecting performance of the sensor must be ensured by cleaning the sensor when the same is dirty or by cleaning the same periodically.

To the present end, cleaning liquid is sprayed onto the sensor, and then high-pressure compressed air is sprayed onto the same to clean the sensor. However, when the pressure of the compressed air used in the cleaning process of the sensor is low, the cleaning liquid used in the cleaning process remains, deteriorating the detecting accuracy of the sensor. Therefore, compressed air used in the cleaning process of the sensor needs be compressed to a high pressure of up to 10 bar and instantly sprayed to completely remove the liquid remaining on the sensor within a short time.

Meanwhile, when atmospheric air is compressed to a high pressure, the air includes a large amount of water vapor during the compression process. However, when the large amount of water vapor is sprayed onto the sensor, the water vapor causes a problem in that the sensor is not cleaned properly. Therefore, it is important to supply dry compressed air, containing water vapor below a predetermined level.

Furthermore, because numerous components are mounted on the vehicle and are electronically controlled, it is most important that a compressed air supply actuator mounted on the vehicle is manufactured to minimize the weight and volume thereof and to be operated by a simple control method.

Therefore, there is a great need to provide a compressed air supply actuator for a vehicle, configured to supply compressed air at a very high pressure and in a dry state to instantly remove cleaning liquid used in cleaning a sensor, having a small weight and compact structure optimized for installation on the vehicle, and configured for being operated with a simple control method.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a compressed air supply actuator for a vehicle configured to spray air compressed higher than a predetermined pressure to remove residual liquid from a sensor of the vehicle in a short time.

Another object of the present disclosure is to remove excess moisture generated in a process of compressing air to a high pressure to instantaneously spray dry the air compressed higher than a predetermined pressure.

Another object of the present disclosure is to automatically regenerate adsorbent in a drying unit, the adsorbent serving to absorb moisture from compressed air, spraying dry compressed air semi-permanently without replacing components.

Another object of the present disclosure is to enable easy switching between a mode of spraying compressed air and a mode of regenerating a drying unit with simple control.

Various aspects of the present disclosure are directed to providing a compressed air supply actuator configured to utilize a passage from a drying unit to a storage tank in a flow path of compressed air for both spraying compressed air and regenerating the drying unit an to an include a compact structure, occupy less volume and be lighter, so that the usability of the actuator for mounting in a vehicle increases.

Various aspects of the present disclosure are directed to providing an actuator for supplying compressed air for a vehicle, the actuator including a compression unit configured to compress air from outside to form high-pressure compressed air, a drying unit configured to receive the compressed air compressed to the predetermined pressure by the compression unit via a movement passage connecting the compression unit and a first portion of the drying unit to remove moisture from the compressed air, and a storage tank connected to the drying unit via a connecting passage connected to a second portion of the drying unit and configured to store the compressed air passing through the drying unit to be supplied to the vehicle.

In an exemplary embodiment of the present disclosure, when the pressure in the storage tank reaches a predetermined pressure value, a control valve may be opened to discharge the compressed air in the storage tank to the outside through a discharge port, preventing the pressure in the storage tank from exceeding a permissible range.

In another exemplary embodiment of the present disclosure, the pressure of the compressed air to be discharged through a discharge passage may be set to 10 bar or above and stored in the storage tank at 10 bar or above 10 bar. Accordingly, high-pressure compressed air may be stored in the storage tank and be sprayed, completely removing foreign substances and liquid adhered to a sensor within a short time period.

In yet another exemplary embodiment of the present disclosure, the actuator may further include an exhaust passage extending from a third portion of the drying unit, and a regeneration valve provided at the exhaust passage, so that, by closing an opening/closing valve and opening the regeneration valve, the compressed air may be discharged from the storage tank through the drying unit to the exhaust passage while moisture inside the drying unit is discharged to the outside to perform a regeneration process for an adsorbent in the drying unit.

In yet another exemplary embodiment of the present disclosure, the regeneration valve may be periodically opened to periodically regenerate the adsorbent in the drying unit.

In still yet another exemplary embodiment of the present disclosure, the drying unit and the compression unit may be combined into one body, which is a compact structure which is easy to install in a limited space in the vehicle.

In a further exemplary embodiment of the present disclosure, the compression unit may include a pump motor configured to rotate a rotation shaft, and a compressing portion, including a piston configured to move up and down by eccentric rotation of a rotation receiving portion configured to receive an eccentric rotation shaft, a cylinder disposed at a reciprocating stroke of the piston, and a compressing portion body configured to receive the piston and the cylinder, and configured to compress air from outside into the compressed air in the cylinder.

In another further exemplary embodiment of the present disclosure, the pump motor may include a stator provided inside a housing and having formed therein a hollow portion, and a rotor, including an annular shape, including N-pole permanent magnets and S-pole permanent magnets alternately disposed in a circumferential direction thereof, wherein a boundary between the N-pole permanent magnet and the S-pole permanent magnet is inclined at an acute angle with respect to the rotation shaft, and configured to rotate integrally with the rotation shaft. Accordingly, because the rotor including an annular shape includes N-pole permanent magnets and S-pole permanent magnets alternately disposed thereon, and the boundary between the N-pole permanent magnet and the S-pole permanent magnet is inclined at an acute angle with respect to the axial direction of the rotation shaft, the cogging torque generated from the pump motor may be reduced and thus air may be compressed with a greater efficiency.

In yet another further exemplary embodiment of the present disclosure, the drying unit may have formed therein a drying passage, disposed at a position communicating with the movement passage, through which the compressed air passes, and accommodating therein an adsorbent for adsorbing moisture to allow moisture contained in the compressed air to be adsorbed while the compressed air passes through the drying passage toward the storage tank.

In yet another further exemplary embodiment of the present disclosure, the drying passage may be disposed in parallel in an odd number of three or more, including a first drying passage, a second drying passage, and a third drying passage, and the compressed air may sequentially pass through the first drying passage, the second drying passage, and the third drying passage so that moisture contained in the compressed air may be completely removed, wherein the inlet and outlet of the drying unit may be disposed opposite each other.

In still yet another further exemplary embodiment of the present disclosure, the actuator may further include a heat dissipation coil configured to heat the drying passage, so that, when the regeneration valve is opened, the heat dissipation coil may heat the drying passage to perform a regeneration process.

In a still further exemplary embodiment of the present disclosure, the drying unit may further include a fixation plate disposed at the end portion of the adsorbent, and configured to prevent outflow of the adsorbent and allow the compressed air to flow, and a spring provided to allow an elastic restoring force for pushing the fixing plate to act to bring the adsorbents accommodated in the drying passage into contact with each other, allowing the adsorbents accommodated in the drying passage to be always disposed at a constant density by being brought into contact with each other, so that the efficiency of adsorbing moisture from the compressed air may be kept constant.

In yet another further exemplary embodiment of the present disclosure, the compressing portion may further include a side body cover, configured to close one side at which the cylinder is located and one side of the drying unit, coupled to one side of the compressing portion body, and having formed therein the movement passage extending from the cylinder to the drying unit.

In a yet still further exemplary embodiment of the present disclosure, the compressing portion may further include another side body cover, configured to close another side of the compressing portion body and another side of the drying unit, coupled to the other side of the compressing portion body, and having formed therein a portion of the connecting passage extending from the drying unit to the storage tank.

Other aspects and exemplary embodiments of the present disclosure are discussed infra.

It is to be understood that the term “vehicle” or “vehicular” or other similar terms as used herein are inclusive of motor vehicles in general, such as passenger automobiles including sports utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The above and other features of the present disclosure are discussed infra.

### BRIEF DESCRIPTION OF THE DRAWINGS

FIG. 1 is a perspective view exemplarily illustrating a compressed air supply actuator for a vehicle according to an exemplary embodiment of the present disclosure;

FIG. 2 is a perspective view exemplarily illustrating the compressed air supply actuator for a vehicle of FIG. 1 from which a storage tank is excluded;

FIG. 3 is an air circuit diagram illustrating a flow path in the compressed air supply actuator for a vehicle of FIG. 1;

FIG. 4 is an exploded perspective view of FIG. 2;

FIG. 5 is an enlarged perspective view exemplarily illustrating a rotor in a pump motor of FIG. 4;

FIG. 6 is an enlarged perspective view of a compressing portion of FIG. 4;

FIG. 7 is an enlarged perspective view of a piston body of FIG. 6;

FIG. 8 is an exploded perspective view of a drying unit of FIG. 4;

FIG. 9A, FIG. 9B, FIG. 9C, and FIG. 9D illustrate a system configured to discharge compressed air through a discharge port;

FIG. 9B is a cross-sectional view taken along a line X1-X1 (FIG. 9A) of the compressed air supply actuator for a vehicle in FIG. 2, illustrating the path of compressed air flowing from a compression unit to a drying unit;

FIG. 9D is a cross-sectional view taken along a line X2-X2 (FIG. 9C) of the compressed air supply actuator for a vehicle in FIG. 2, illustrating the path of compressed air flowing from a drying unit to a discharge port;

FIG. 10 is a diagram illustrating a discharge path of compressed air in the air circuit diagram of FIG. 3;

FIG. 11A, FIG. 11B, FIG. 11C, FIG. 11D, FIG. 11E and FIG. 11G illustrate a system configured to remove moisture from a drying unit;

FIG. 11A is a cross-sectional view taken along a line X2-X2 (FIG. 9C) of the compressed air supply actuator for a vehicle in FIG. 2, illustrating the path of compressed air flowing from a storage tank to a drying unit;

FIG. 11C is a cross-sectional view taken along a line X3-X3 (FIG. 11B) of the compressed air supply actuator for a vehicle in FIG. 2, illustrating the path of compressed air flowing from a drying unit to a compressing portion;

FIG. 11E and FIG. 11G are cross-sectional views taken along lines X4-X4 and X5-X5 (FIG. 11D and FIG. 11F) of the compressed air supply actuator for a vehicle in FIG. 2, illustrating the path of compressed air flowing from a compressing portion casing to an exhaust port; and

FIG. 12 is a diagram illustrating a discharge path of compressed air in the air circuit diagram of FIG. 3.

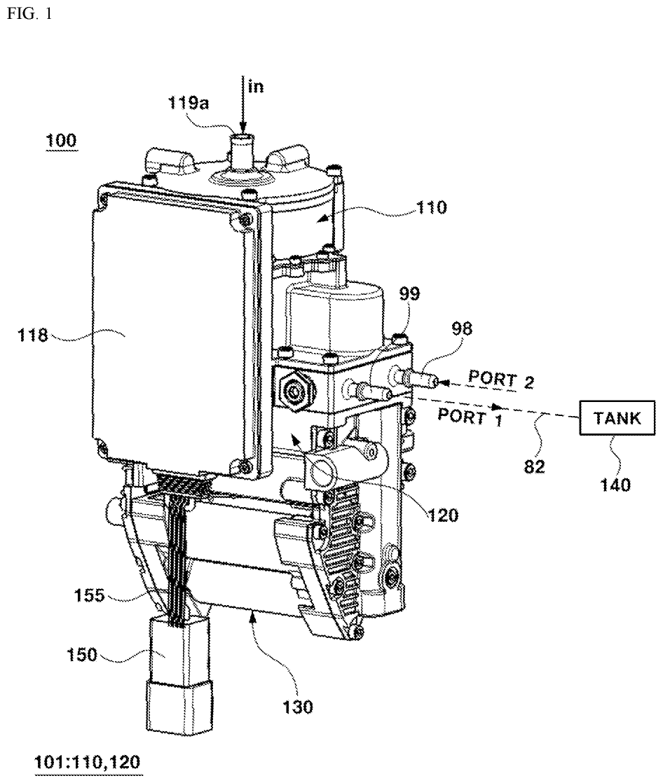

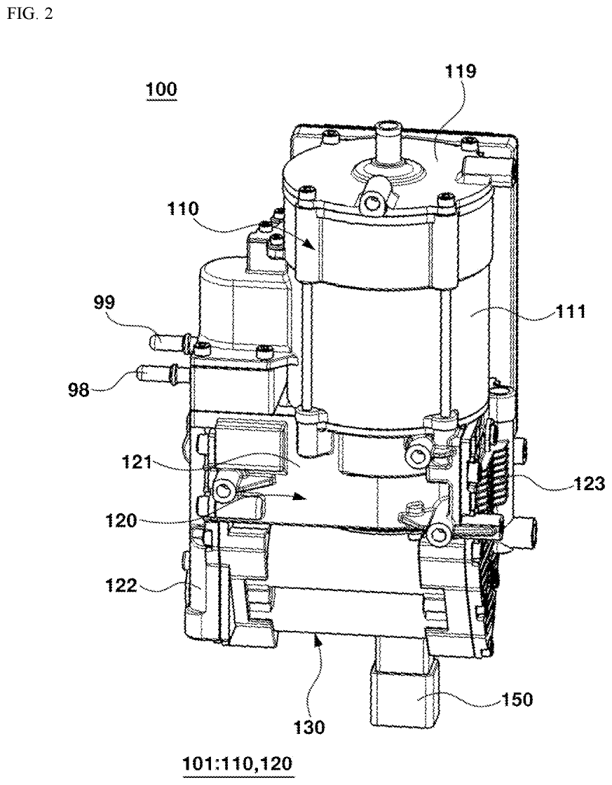

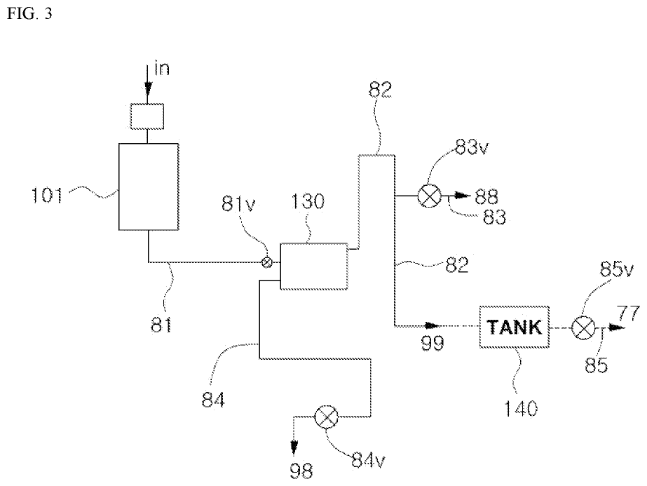

It should be understood that the appended drawings are not necessarily to scale, presenting a somewhat simplified representation of various exemplary features illustrative of the basic principles of the present disclosure. The specific design features of the present disclosure as disclosed herein, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Embodiments of the present disclosure will be described in detail with reference to the accompanying drawings, but the present disclosure is not limited to these embodiments. For reference, in the present specification, like reference numerals denote like elements, and descriptions may be made by citing contents described in other drawings under these rules, and contents determined to be obvious to those skilled in the art or repeated contents may be omitted.

“Axial direction of the rotation shaft” and similar terms thereto described in the present specification and claims are defined as referring to the longitudinal direction of the rotation shaft in which the rotation shaft extends.

“Eccentric rotation,” “revolution,” and similar terms thereto described in the present specification and claims are defined as referring to a motion rotating along a circular trajectory connecting a position spaced apart by an eccentric distance from the rotation center portion of the rotation shaft.

As illustrated in the drawing, a compressed air supply actuator 100 for a vehicle according to various exemplary embodiments of the present disclosure includes a compression unit 101 configured to compress air from outside to form high-pressure compressed air, a drying unit 130 configured to receive the compressed air compressed to a high pressure by the compression unit 101 via a movement passage 81 to remove moisture from the compressed air, and a storage tank 140 connected to the drying unit 130 via a connecting passage 82 and a connecting port 99 and configured to store the compressed air passing through the drying unit 130, a control valve 83v provided to open or close a discharge port 88 of a control passage 83 branched from the connecting passage 82 interconnecting the drying unit 130 with the storage tank 140, a discharge valve 85v configured to open or close a discharge port 77 formed at the end portion of a discharge passage 85 extending from the storage tank 140, a regeneration valve 84v configured to open or close an exhaust passage 84 extending from the inlet of the drying unit 130 to an exhaust port 98, a check valve 81v provided at the inlet of the drying unit 130, and a controller 150 configured to control a pump motor 110 and the valves 81v, 83v, 85v, and 84v of the compression unit 101.

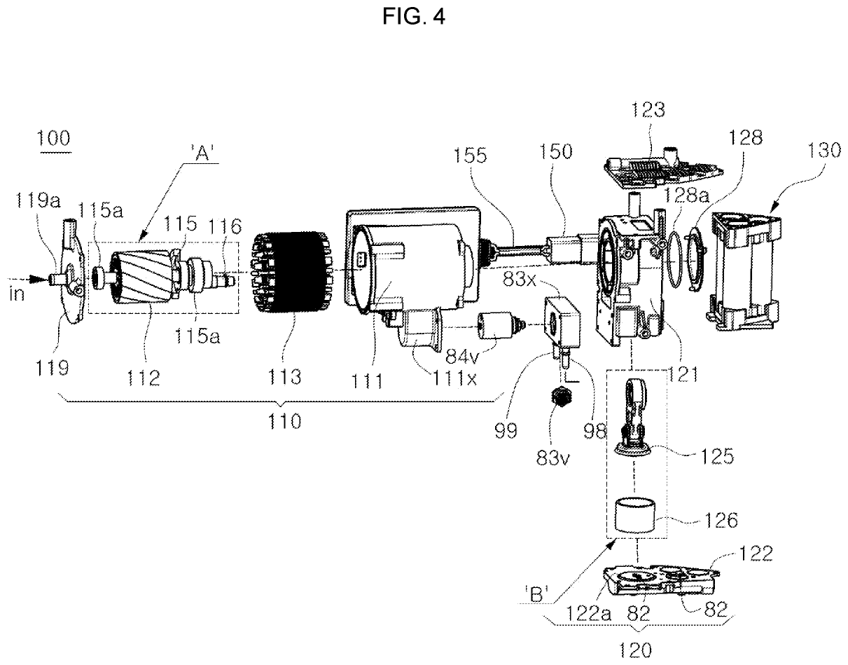

The compression unit 101 includes, as illustrated in FIG. 4, the pump motor 110 configured to rotate a rotation shaft 115, and a compressing portion 120 configured to generate compressed air by being driven by the pump motor 110.

Here, the pump motor 110 includes a housing 111 provided therein with an accommodating space, a stator 113 provided inside the housing 111 and having formed therein a hollow portion, a rotor 112 spaced from the stator 113 with a predetermined distance and rotatably provided in the hollow portion in the stator 113, the rotation shaft 115 configured to rotate integrally with the rotor 112, and an eccentric rotation shaft 116 protruding in an axial direction from a position spaced from the rotation center portion of the rotation shaft 115 by a predetermined eccentric distance e and configured to rotate eccentrically. Here, the rotor 112 has opposite axial sides each provided with a bearing 115a configured to support the rotation shaft 115 while rotating, so that the eccentric rotation shaft 116 may rotate eccentrically in a cantilever form.

The housing 111 includes a receiving portion 111x configured to fix the discharge valve 85v and the regeneration valve 84v in place, and is integrated with a fixation plate 118 configured to fix the compressed air supply actuator 100.

The stator 113 is disposed inside the housing 111, and has wound thereon a coil configured to receive direct current power from outside. The rotor 112 is a magnet including an annular shape, in which N-pole permanent magnets 112N and S-pole permanent magnets 112S are alternated in the circumferential direction thereof. Furthermore, the rotor 112 includes a boundary between the N-pole permanent magnet and the S-pole permanent magnet inclined at an acute angle of 5 to 30 degrees with respect to the axial direction of the rotation shaft 115, and may rotate integrally with the rotation shaft 115. Because the rotor 112 having an annular shape includes permanent magnets inclined at a predetermined acute angle with respect to the axial direction of the rotation shaft 115, cogging torque between the stator 113 and the rotor 112 may be reduced.

The pump motor 110 may be a direct current motor. The pump motor 110 may be a brushless direct current motor (BLDC motor) to obtain an advantage of being able to adjust the output in various ways depending on the load.

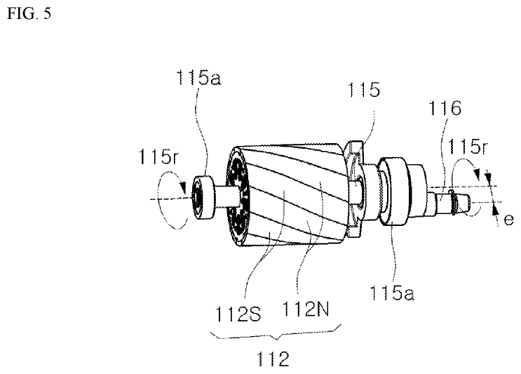

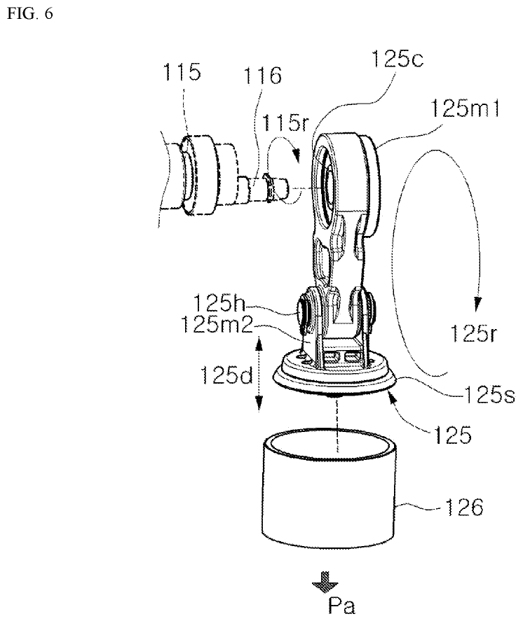

As illustrated in FIG. 5, the rotation shaft 115 includes an end portion including the eccentric rotation shaft 116 integrally connected thereto at a position spaced from the rotation center portion of the rotation shaft 115 by the eccentric distance e. Accordingly, when the rotation shaft 115 is rotated by the pump motor 110, the eccentric rotation shaft 116 revolves along a circular path spaced from the rotation center portion of the rotation shaft 115 by the eccentric distance e.

The compressing portion 120 includes a compressing portion body 121 provided with an accommodating space configured to accommodate at least a portion of the eccentric rotation shaft 116, a side body cover 122 coupled to one side of the compressing portion body 121, another side body cover 123 coupled to another side of the compressing portion body 121, a piston assembly 125 accommodated in the accommodating space in the compressing portion body 121 and configured to reciprocate by the eccentric rotation of the eccentric rotation shaft 116, and a cylinder 126 extending in a straight line to guide the reciprocating path of a piston member 125p of the piston assembly 125.

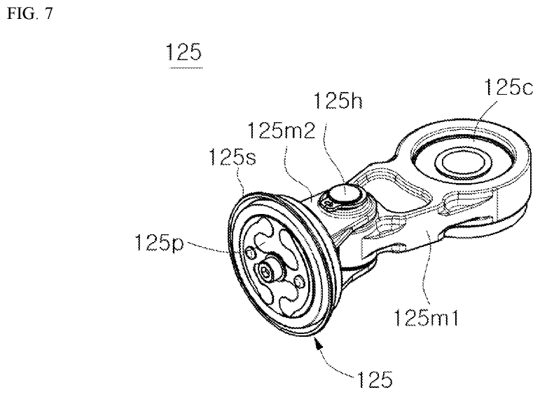

Here, the piston assembly 125 includes, as illustrated in FIG. 7, an input portion 125m1 located at one side with respect to the hinge shaft 125h and including a receiving hole 125c into which the eccentric rotation shaft 116 is inserted, and an operating portion 125m2 located at another side with respect to the hinge shaft 125h and configured to reciprocate inside the cylinder 126. In other words, as the eccentric rotation shaft 116 inserted into the receiving hole 125c revolves along the circular path spaced apart by the eccentric distance e from the rotation center portion of the rotation shaft 115, the input portion 125m1 also undergoes a revolving motion 125r and the rotational displacement of the operating portion 125m2 connected to the input portion 125m1 via the hinge shaft 125h is constrained by the internal wall of the cylinder 126. Accordingly, the operating portion 125m1 undergoes a reciprocating linear motion 125d inside the cylinder 126 by a stroke having a length corresponding to the diameter of the revolving motion 125r of the input portion 125m1.

Here, the operating portion 125m1 includes a lower end portion provided with the piston member 125p, and the piston member 125p includes a circumference provided with a sealing ring 125s brought into close contact with the internal wall of the cylinder 126. External air introduced through one bearing 115a of the pump motor 110 is compressed to a high pressure inside the cylinder 126 for each reciprocating stroke of the piston member 125p of the compressing portion 120, and the air compressed to a high pressure in the cylinder 126 is transferred to the drying unit 130 through the movement passage 81.

Meanwhile, the one side body cover 122 is coupled to one side of the compressing portion body 121 and to one side of the drying unit 130 while closing the one side at which the cylinder 126 is located and the one side of the drying unit 130. Furthermore, the one side body cover 122 has formed therein the movement passage 81 interconnecting the cylinder 126 of the compressing portion 120 with the drying unit 130. Accordingly, the compressed air generated in the cylinder 126 by the reciprocating motion of the piston member 125p in the compressing portion 120 is transferred from the cylinder 126 to the inlet of the drying unit 130 through the movement passage 81.

Similarly, the other side body cover 123 is coupled to another side of the compressing portion body 121 and to another side of the drying unit 130 by closing the other side of the compressing portion body 121 and the other side of the drying unit 130. Furthermore, the other side body cover 123 includes a portion of the connecting passage 82 extending from the outlet oo of the drying unit 130 to the storage tank 140. Accordingly, the compressed air dried while passing through the drying unit 130 moves to the storage tank 140 through the connection passage 82, and when compressed air is generated in the compressing portion 120, the pressure of the compressed air accommodated in the storage tank 140 gradually increases.

Accordingly, in the compressed air supply system 100 according to an exemplary embodiment of the present disclosure, the compression unit 101 and the drying unit 130 are integrated into one body by the body covers 122 and 123, having a compact structure with a small volume as a whole, and thus the same occupies less installation space in the vehicle. Furthermore, the body covers 122 and 123, configured to couple the compression unit 101 and the drying unit 130 together into one body, have formed therein the movement passage 81, the connecting passage 82, and a flow passage interconnecting the drying passages P1, P2, and P3 to be described later, and the exhaust passage 84, minimizing the assembly process to form a flow path and implementing a compact structure.

Moreover, in an exemplary embodiment of the present disclosure, moisture in the compressed air is removed by the adsorbent 132 provided in each of the drying passages P1, P2, and P3 while the compressed air passes through odd number of three rows of the drying passages P1, P2, and P3 in a zig-zag shape, more reliably generating dry compressed air. Furthermore, because the inlet ii of the drying unit 130 and the outlet oo of the drying unit 130 are disposed in opposite directions, the movement passage 81 from the compression unit 101 to the inlet ii of the drying unit 130 and the connecting passage 82 from the outlet oo of the drying unit 130 to the storage tank 140 may be disposed at different sides, more easily designing the layout of the passage.

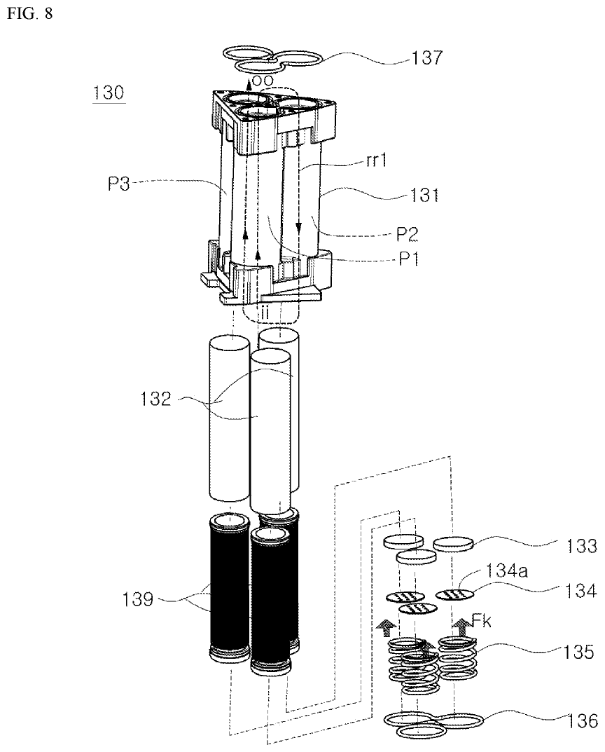

The drying unit 130 includes, as illustrated in FIG. 8, a drying case 131 including three rows of hollow passages P1, P2, and P3, the adsorbent 132 inserted into each row of the drying case 131, a filter 133 provided to be brought into close contact with one end portion of the absorbent 132, a fixation plate 134 brought into close contact with the filter 133 and having formed therein a plurality of through holes 134a, a spring 135 configured to push the fixation plate 134 toward the adsorbent 132, o-rings 136 and 137 provided at opposite end portions of the drying case 131, respectively, and configured to prevent leakage of compressed air, and a heat dissipation coil 139 configured to heat the adsorbent 132 disposed in the drying passage during the regeneration process of the adsorbent 132.

Here, the drying case 131 has formed therein three rows of hollow passages, which are a first drying passage P1, a second drying passage P2, and a third drying passage P3 provided parallel to one another. Among the passages, the inlet ii of the first drying passage P1 communicates with the movement passage 81 extending from the compression unit 101, whereby compressed air generated in the compressing portion 120 and transferred to the movement passage 81 is introduced into the first drying passage in the drying case 131.

The outlet of the first drying passage P1 communicates with the inlet of the second drying passage P2 by the other side body cover 123, and the outlet of the second drying passage P2 communicates with the inlet of the third drying passage P3 by the one side body cover 122. Accordingly, the compressed air transferred from the drying unit 130 moves through a path rr1 where the same sequentially passes through the first drying passage P1, the second drying passage P2, and the third drying passage P3, and becomes dry while being deprived of moisture by the adsorbent 132 filling the drying passages P1, P2, and P3.

The adsorbent 132 is inserted into each of the drying passages P1, P2, and P3, and is configured to lower the humidity of the compressed air by taking moisture from the compressed air passing therethrough. Here, as the adsorbent 132, alumina, silica, aluminum molecular sieve, etc and materials in combination thereof configured for removing and containing moisture may be variously applied.

Here, depending on the density of the adsorbent 132 filling the drying passages P1, P2, and P3, a deviation may occur in the amount of moisture removed from the compressed air passing through the drying passages P1, P2, and P3. Accordingly, as illustrated in FIG. 8, in a state in which the fixation plate 134 blocks one end portion of the adsorbent 132 so that the adsorbent 132 does not flow out, the fixation plate 134 is pushed toward the absorbent by the spring 135 provided so that the elastic restoring force Fk pushing the fixed plate 134 acts, and thus the adsorbents 132 in granular form are brought into close contact with each other by the pushing force of the spring 135 via the fixing plate 134, allowing the density of the adsorbent 132 to always be kept constant. Accordingly, the amount of moisture absorbed from the compressed air passing through the adsorbent 132 may be controlled to be constant.

The heat dissipation coil 139 heats the adsorbent 132 provided in the drying passages P1, P2, and P3 during a regeneration mode in which moisture is removed from the adsorbent 132 in the drying unit 130. For example, the heat dissipation coil 139 increases the temperature of the adsorbent 132 to 120° C. to 250° C. in the regeneration mode to heat and separate moisture adsorbed on the adsorbent 132. Accordingly, when the check valve 81v, the control valve 83v, and the discharge valve 85v are in a closed state CLOSE, and the regeneration valve 84v is opened OPEN, compressed air from the storage tank 140 reaches the outlet oo of the drying unit 130 via the connecting passage 82, and then sequentially passes through the third drying passage P3, the second drying passage P2, and the first drying passage P1 in the drying unit 130 in a state in which the adsorbent 132 provided in the drying passages P1, P2, and P3 is heated by the heat dissipation coil 139, whereby moisture is contained in the adsorbent 132. Thereafter, the compressed air reaches the inlet ii of the first drying passage P1 in the state of containing moisture, and then passes through the exhaust passage 84 to be discharged through the exhaust port 98. Accordingly, the moisture absorbed by the drying unit 130 is discharged to the outside thereof, so that the drying unit 130 is in a dry state and is ready to adsorb moisture from new compressed air. Such a regeneration mode is performed periodically, so that compressed air to be sprayed at high pressure on the sensor through the discharge port 77 may be continuously generated in a dry state.

The storage tank 140 is disposed at a location separate from the compression unit 101 and the drying unit 130 and is connected to the drying unit 130 via the connecting passage 82. The storage tank 140 accommodates therein compressed air generated by the compressing portion 120 of the compression unit 101.

The controller 150 is configured to control the pump motor 110, the check valve 81v, the discharge valve 85v, and the regeneration valve 84v using a control signal line 155. In a state in which the pressure in the storage tank 140 reaches a predetermined value, the controller 150 periodically opens the discharge valve 85v for a short time period (e.g., 0.5 to 3 seconds) to periodically spray high-pressure compressed air onto the sensor of the vehicle facing the discharge port 77. For example, in a state in which the pressure in the storage tank 140 reaches 10 bar, the controller 150 may open the discharge valve 85v to remove foreign matter or liquid remaining on the surface of the sensor of the vehicle with high-pressure compressed air of 10 bar or above within a short time.

Meanwhile, the controller 150 includes a receiver configured to receive weather information around the vehicle via Internet, Bluetooth, 5G wireless communication, etc. When the receiver receives information in which the weather condition around the vehicle is raining or snowing, the controller 150 sets the opening cycle of the discharge valve 85v to be shorter, and sprays high-pressure compressed air to the vehicle sensor at shorter intervals in such weather where the sensor is easily soiled, maintaining the detecting performance of the vehicle sensor.

Meanwhile, when the pressure of the compressed air in the storage tank 140 approaches the first pressure value (e.g., 20 bar), which is the upper limit of the pressure, the controller 150 opens the control valve 83v, regardless of the opening cycle of the discharge valve 85v, to discharge the compressed air through the discharge port 88 to thereby lower the pressure in the storage tank 140 at or below a permissible value.

Hereinafter, the operating principle of the compressed air supply actuator 100 according to various exemplary embodiments of the present disclosure having the structure as described above will be described.

In the compressed air supply actuator 100 having the structure as described above, when the control valve 83v and the regeneration valve 84v are closed CLOSE and the discharge valve 85v is opened OPEN in a state in which the pressure in the storage tank 140 reaches a predetermined value, high-pressure compressed air is sprayed through the discharge port 77. Conversely, when the regeneration valve 84v is opened OPEN and the control valve 83v and the discharge valve 85v are closed CLOSE, the high-pressure compressed air stored in the storage tank 140 passes through the drying unit 130 and is discharged through the exhaust port 98. In the present process, moisture is discharged from the adsorbent 132 in the drying unit 130 to the outside and the adsorbent 132 is regenerated.

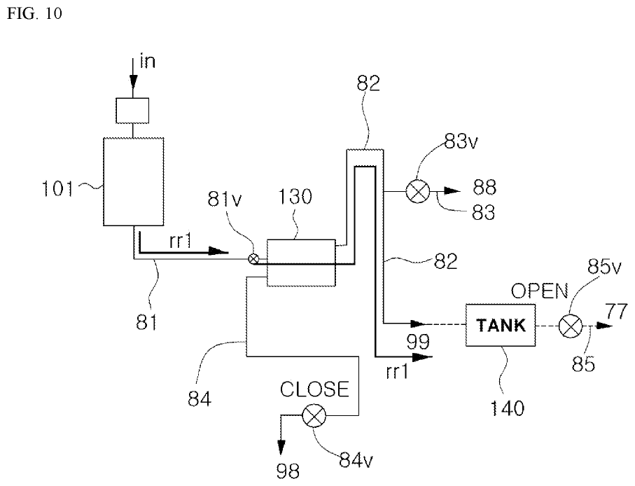

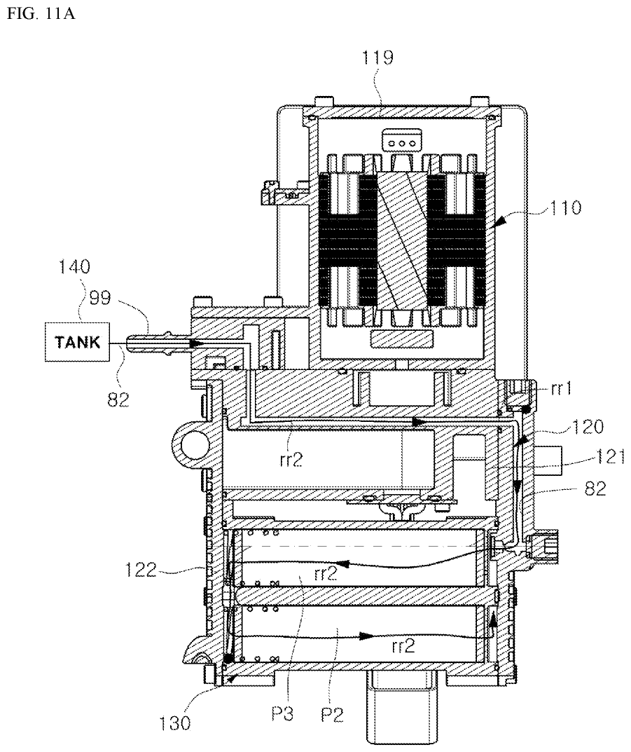

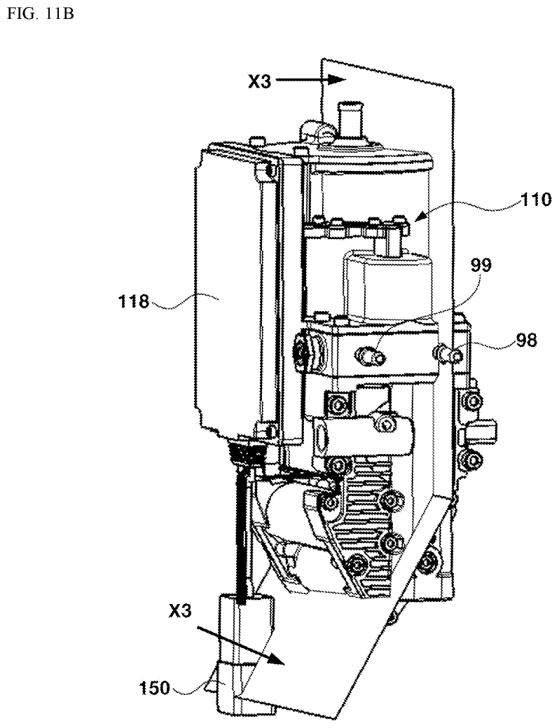

In a process of cleaning and drying the sensor of the vehicle by periodically spraying high-pressure compressed air, the compressed air is transferred along the supply path rr1 shown in FIG. 10.

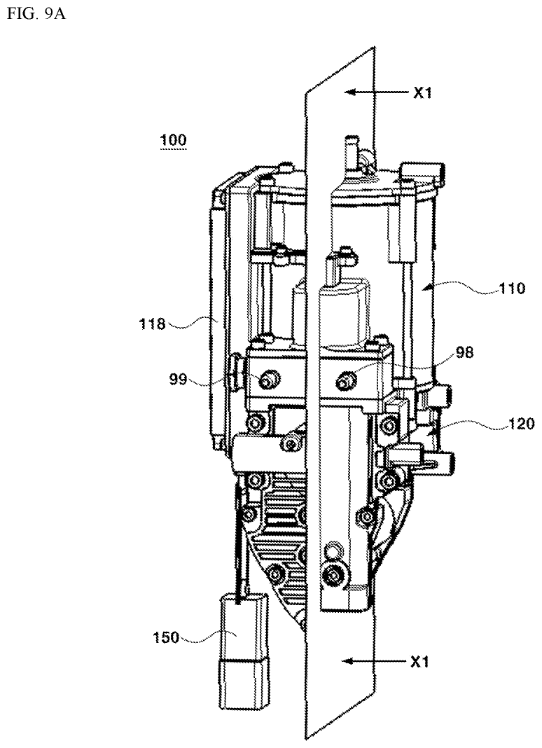

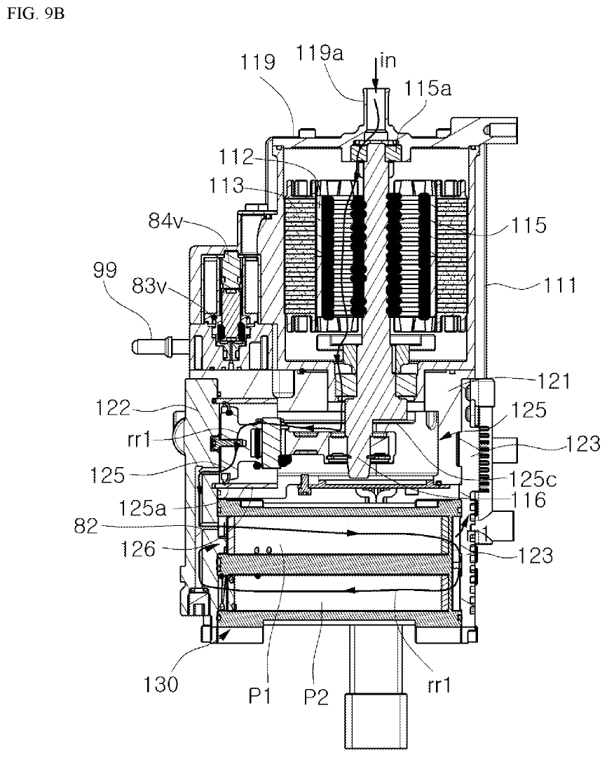

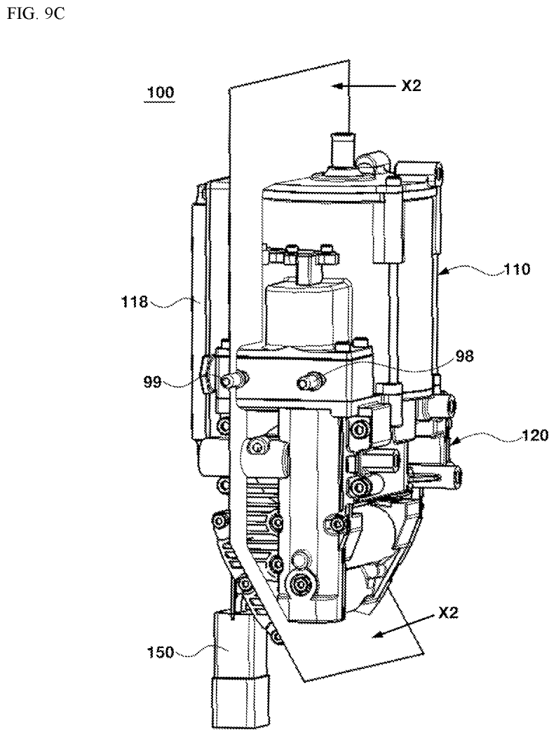

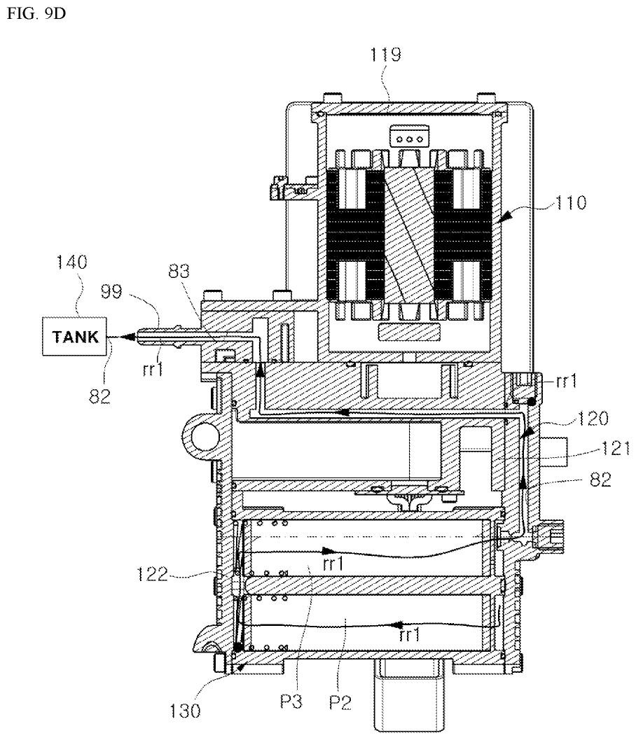

In other words, as illustrated in FIG. 9B, when the compression unit 101 operates, the pump motor 110 eccentrically rotates the eccentric rotation shaft 116. Accordingly, the receiving hole 125c being the input portion 125m1 of the piston assembly 125 and accommodating therein the eccentric rotation shaft 116 rotates eccentrically, allowing the operating portion 125m2 of the piston assembly 125 to make a reciprocating linear motion inside the cylinder 126. In the present process, air from outside is compressed inside the cylinder 126 to become compressed air.

The compressed air generated in the compressing portion 120 of the compression unit 101 is transferred to the drying unit 130 through the movement passage 81 formed in the one side body cover 122. Here, the check valve 81v disposed at the movement passage 81 is maintained in the OPEN state, and the regeneration valve 84v is maintained in the CLOSE state.

As illustrated in FIGS. 9B and 9D, compressed air reaching the inlet of the drying unit 130 sequentially passes through three parallel rows of the first drying passages P1, the second drying passage P2, and the third drying passage P3 in the drying unit 130 in a zig-zag shape. In the present process, the compressed air containing moisture while being compressed at a high pressure transfers the moisture to the adsorbent 132 and becomes dry.

Furthermore, as illustrated in FIG. 9D, the compressed air dried while passing through the drying unit 130 passes through the connecting passage 82 including a portion formed in the other side body cover 123 and the compressing portion body 121, and the connecting passage 82 in the compressing portion body 121 extending continuously from the connection passage 82 in the compressing portion body 121 to the outside and extending to the external storage tank 140 to be accommodated in the storage tank 140.

The compression unit 101 generates compressed air in the compressing portion 120 and transfers the same to the storage tank 140 while maintaining the pressure in the storage tank 140 to be greater than a predetermined discharge pressure and smaller than an allowable pressure of the storage tank 140. Accordingly, the compressed air generated by the compression unit 101 passes through the drying unit 130 and is accommodated in the storage tank 140. In the present process, the pressure in the storage tank 140 is increased, and thus the pressure in the storage tank 140 is maintained greater than the discharge pressure (e.g., 10 bar) discharged through the discharge port 77. To the present end, the compression unit 101 continuously or intermittently generates compressed air and supplies the same to the storage tank 140, and the pressure of the compressed air accommodated in the storage tank 140 increases.

Here, when the pressure of the compressed air accommodated in the storage tank 140 reaches the first pressure value close to the allowable limit of the storage tank 140, the control valve 83v is opened to maintain the pressure of the compressed air accommodated in the storage tank 140 within an appropriate range. In addition, the controller 150 may stop the operation of the compression unit 101 when the pressure in the storage tank 140 is greater than the predetermined discharge pressure and is smaller than the allowable pressure of the storage tank 140, and may resume the operation of the compression unit 101 when the pressure in the storage tank 140 becomes smaller than the predetermined discharge pressure. Accordingly, the storage tank 140 maintains a ready state in which dry compressed air may be discharged through the discharge port 77.

In addition, the discharge valve 85v is periodically opened OPEN, so that the compressed air accommodated in the storage tank 140 passes through the discharge passage 85 extending from the storage tank 140 to thereby be sprayed on the sensor of the vehicle at a high pressure through the discharge port 77 for a predetermined time (e.g., 0.5 to 3 seconds).

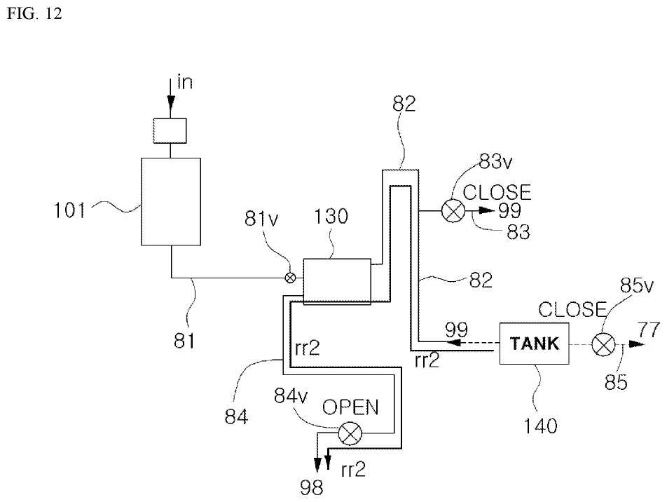

Meanwhile, as described above, when high-pressure compressed air is continuously sprayed through the supply path rr1, the adsorbent 132 in the drying unit 130 becomes excessive in moisture and cannot absorb moisture from the compressed air any longer. For the present reason, the regeneration mode, in which compressed air is transferred in the opposite direction along a regeneration path rr2 illustrated in FIG. 12 to discharge moisture from the adsorbent 132 in the drying unit 130 to the outside to allow the adsorbent 132 to absorb moisture, is performed periodically.

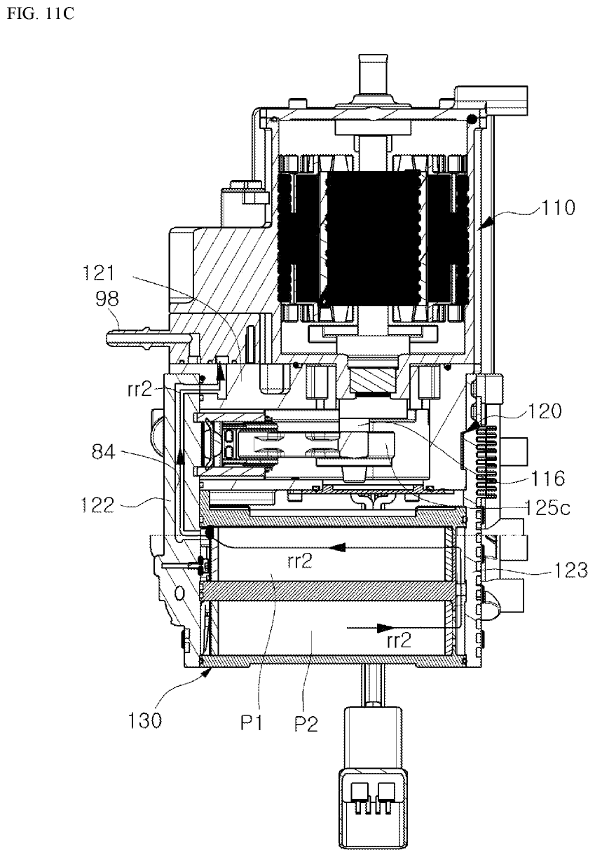

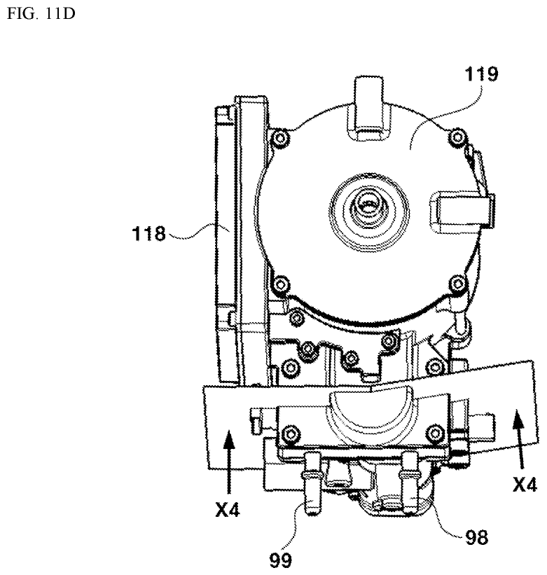

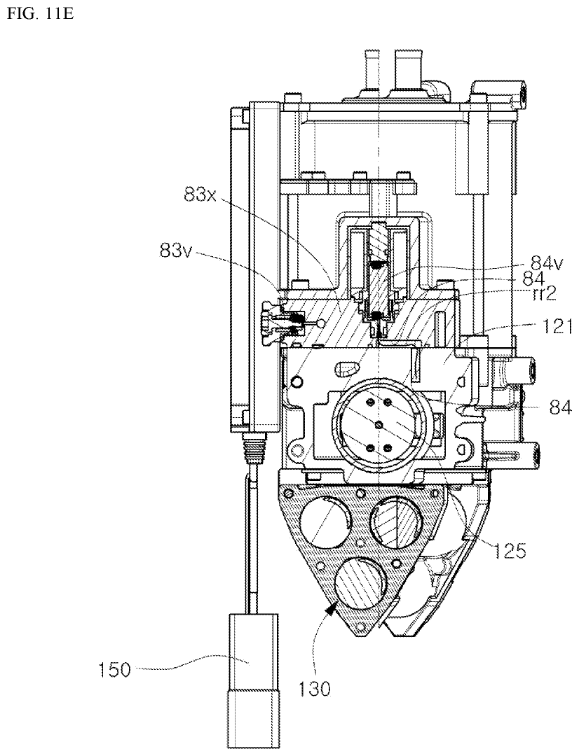

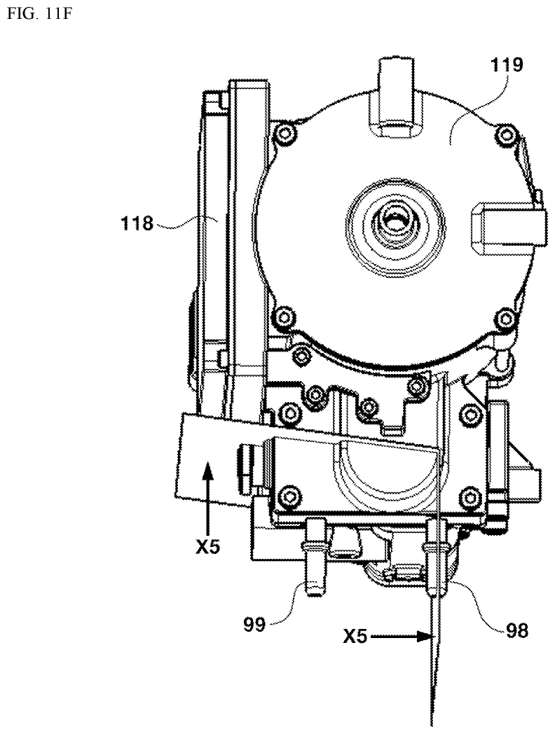

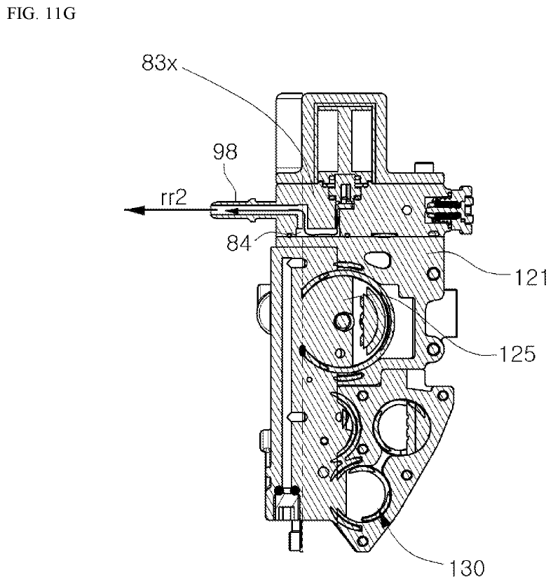

In other words, as illustrated in FIG. 11A, when the check valve 81v, the control valve 83v, and the discharge valve 85v are closed CLOSE and the regeneration valve 84v is opened OPEN, the compressed air accommodated in the storage tank 140 is transferred to the exhaust passage 84 via the connecting passage 82 and the drying unit 130 because the pressure in the exhaust passage 84 maintained at approximately atmospheric pressure is smaller than the pressure in the connecting passage 82 filled with the compressed air.

In other words, as illustrated in FIGS. 11A and 11C, compressed air reaching the outlet oo of the third drying passage P3 in the drying unit 130 sequentially passes through three parallel rows of the third drying passage P3, the second drying passage P2, and the first drying passage P1 in the drying unit 130 in a zig-zag shape. Here, as the adsorbent is heated to an appropriate temperature by the heat dissipation coil 139, a process of desorbing moisture from the adsorbent 132 is performed. Accordingly, the compressed air sequentially passing through the third drying passage P3, the second drying passage P2, and the first drying passage P1 in a zig-zag shape contains moisture desorbed from the adsorbent 132, and the compressed air containing moisture desorbed from the adsorbent 132 passes through the exhaust passage 84 and is discharged outside through the exhaust port 98.

Here, the exhaust passage 84 includes a portion formed in the one side body cover 122 and the compressing portion body 121, as illustrated in FIG. 11C. Accordingly, when the one side body cover 122 is coupled to the compressing portion body 121, the exhaust passage 84 may be easily formed.

Furthermore, as illustrated in FIG. 11E and FIG. 11G, compressed air containing moisture passes through the exhaust passage 84 in a valve block 83x where the regeneration valve 84v is disposed, and is discharged through the exhaust port 98. Here, while the regeneration mode is performed, the check valve 81v of the movement passage 81 may be kept in a closed state CLOSE, so that compressed air containing moisture that has passed through the drying unit 130 does not flow into the movement passage 81.

Accordingly, the regeneration mode, in which the compressed air accommodated in the storage tank 140 is transferred and exhausted along the regeneration path rr2 from the storage tank 140 to the exhaust passage 84 via the connecting passage 82 and the drying unit 130 to remove moisture contained in the adsorbent 132 in the drying unit 130, is performed periodically. Accordingly, the air compressed in the compression unit 101 is transferred and dried while passing through the supply path rr1, and then is collected in the storage tank 140 and kept in a standby state so that the same may be sprayed at high pressure through the discharge port 77.

In the compressed air supply system 100 according to an exemplary embodiment of the present disclosure as described above, before spraying the high-pressure compressed air to the vehicle sensor, the compressed air is passed through the drying unit 130 so that moisture contained in the compressed air is removed, increasing the cleaning and drying efficiency for the sensor. Furthermore, the adsorbent in the drying unit is dried and regenerated in the regeneration mode in which compressed air is discharged to the outside through the drying unit 130, so that the adsorbent for supplying dry compressed air may be used semi-permanently without replacement.

Moreover, in an exemplary embodiment of the present disclosure, the compression unit 101 configured to compress air from outside into high-pressure compressed air and the drying unit 130 configured to remove moisture from the high-pressure compressed air are integrated into one body, implementing a compact structure which is easy to mount on a vehicle. Furthermore, among the passages for the compressed air, the connecting passage 82 from the drying unit 130 to the storage tank 140 is used as both the supply path rr1 to spray compressed air and the regeneration path rr2 to regenerate the drying unit 130 to thereby include a compact structure, so that the volume is reduced and the weight is further reduced, and thus the usability for mounting in a vehicle is increased.

In the exemplary embodiment illustrated in the drawing, the drying unit has three parallel drying passages, but the present disclosure is not limited thereto, and includes all structures including three or more odd number of drying passages.

As is apparent from the above description, various aspects of the present disclosure are directed to providing the following effects.

As described above, according to an exemplary embodiment of the present disclosure, high-pressure compressed air at 10 bar or above is generated, stored in a storage tank, and then sprayed on a sensor of a vehicle, removing cleaning fluid remaining on the sensor within a short time.

Furthermore, according to an exemplary embodiment of the present disclosure, before spraying compressed air on the sensor of the vehicle, the compressed air is passed through a drying unit so that moisture in the compressed air is removed and dried, and then the dried compressed air is sprayed on the sensor, increasing drying efficiency for the sensor.

Furthermore, according to an exemplary embodiment of the present disclosure, a regeneration mode in which compressed air is discharged to the outside through a drying unit is performed to discharge moisture, adsorbed from the compressed air and remaining in the drying unit, to the outside and to dry and regenerate an adsorbent in the drying unit, by use of the adsorbent for drying the compressed air semi-permanently.

Furthermore, according to an exemplary embodiment of the present disclosure, a compression unit configured to compress air from outside into high-pressure compressed air and a drying unit configured to remove moisture from the high-pressure compressed air are integrated into one body, making the same not only easier to mount on a vehicle, but also more compact.

Above all, according to an exemplary embodiment of the present disclosure, among the passages for compressed air, a connecting passage from a drying unit to a storage tank is commonly used as both a supply path for spraying compressed air and a regeneration path for regenerating the drying unit to thereby implement a compact structure, so that the volume is reduced and the weight is further reduced, and thus the usability for mounting in a vehicle is increased.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An actuator for supplying compressed air for a vehicle, the actuator comprising:
a compression unit configured to compress air from outside to form air compressed higher than a predetermined pressure;
a drying unit configured to receive the compressed air compressed to the predetermined pressure by the compression unit via a movement passage connecting the compression unit and a first portion of the drying unit to remove moisture from the compressed air; and
a storage tank connected to the drying unit via a connecting passage connected to a second portion of the drying unit and configured to store the compressed air passing through the drying unit to be supplied to the vehicle.

2. The actuator of claim 1, wherein, when a pressure in the storage tank reaches a predetermined pressure value, a control valve connected to the storage tank and configured to lower a pressure in the storage tank is opened.

3. The actuator of claim 1, wherein the compressed air to be discharged through a discharge passage connected to the storage tank is stored in the storage tank at 10 bar or above 10 bar.

4. The actuator of claim 1, further including:
an exhaust passage extending from a third portion of the drying unit; and
a regeneration valve provided at the exhaust passage,
wherein, by opening the regeneration valve, the compressed air in the storage tank is discharged to the exhaust passage through the connection passage and the drying unit sequentially so that moisture inside the drying unit is discharged outside.

5. The actuator of claim 4, wherein the regeneration valve is periodically opened to periodically regenerate an adsorbent in the drying unit.

6. The actuator of claim 1, wherein the drying unit and the compression unit are combined into one body.

7. The actuator of claim 4, wherein the compression unit includes:
a pump motor configured to rotate a rotation shaft; and
a compressing portion, including a piston configured to move up and down by eccentric rotation of a rotation receiving portion configured to receive an eccentric rotation shaft, a cylinder disposed at a reciprocating stroke of the piston, and a compressing portion body configured to receive the piston and the cylinder, and configured to compress the air from outside into compressed air in the cylinder.

8. The actuator of claim 7, wherein the pump motor includes:
a stator provided inside a housing and having formed therein a hollow portion; and
a rotor, having an annular shape, including N-pole permanent magnets and S-pole permanent magnets alternately disposed in a circumferential direction thereof,
wherein a boundary between the N-pole permanent magnet and the S-pole permanent magnet is inclined at an acute angle with respect to the rotation shaft, and configured to rotate integrally with the rotation shaft.

9. The actuator of claim 8, wherein the pump motor is a brushless direct current motor (BLDC).

10. The actuator of claim 4, wherein the drying unit includes a drying passage, fluidically-communicating with the movement passage, through which the compressed air passes, and accommodating therein an adsorbent for adsorbing the moisture, so that the moisture contained in the compressed air is adsorbed while the compressed air passes through the drying passage toward the storage tank.

11. The actuator of claim 10, further including:
a heat dissipation coil configured to heat the adsorbent disposed in the drying passage,
wherein, when the regeneration valve is opened, the heat dissipation coil operates to heat the drying passage.

12. The actuator of claim 11,
wherein the drying passage is disposed in parallel in an odd number of at least three, including a first drying passage, a second drying passage, and a third drying passage, and
wherein the compressed air sequentially passes through the first drying passage, the second drying passage, and the third drying passage.

13. The actuator of claim 11, wherein the drying unit further includes:
a fixation plate disposed at an end portion of the adsorbent, and configured to prevent outflow of the adsorbent and allow the compressed air to flow; and
a spring provided to allow an elastic restoring force for pushing the fixing plate to act to bring the adsorbent accommodated in the drying passage into contact with each other.

14. The actuator of claim 7, wherein the compressing portion further includes a side body cover, configured to close one side at which the cylinder is located and one side of the drying unit, coupled to one side of the compressing portion body, and having formed therein the movement passage extending from the cylinder to the drying unit.

15. The actuator of claim 14, wherein the one side body cover includes a portion of the exhaust passage.

16. The actuator of claim 7, wherein the compressing portion further includes another side body cover, configured to close another side of the compressing portion body and another side of the drying unit, coupled to the other side of the compressing portion body, and having formed therein a portion of the connecting passage extending from the drying unit to the storage tank.

17. The actuator of claim 1, further including a controller configured for:
in a state in which a pressure in the storage tank reaches a predetermined first pressure value, periodically opening a discharge valve connected to the storage tank for a predetermined time period.

18. The actuator of claim 17, wherein the controller is further configured for:
setting an opening cycle of the discharge valve to be shorter than the predetermined time period, when weather condition around the vehicle satisfies a predetermined condition.

19. The actuator of claim 17, wherein the controller is further configured for:
when a pressure of the compressed air in the storage tank approaches a predetermined second pressure value, opening a control valve connected to a control passage branched from the connecting passage, regardless of the opening cycle of the discharge valve.

20. The actuator of claim 1, further including:
an exhaust passage extending from a third portion of the drying unit; and
a regeneration valve provided at the exhaust passage,
wherein the controller is further configured for opening the regeneration valve, so that the compressed air in the storage tank is discharged to the exhaust passage through the connection passage and the drying unit sequentially to discharge the moisture inside the drying unit outside.
